(19) United States
(12) Patent Application Publication
(10) Pub. No.: US 2015/0278452 A1
(43) Pub. Date: Oct. 1, 2015

(54) DETERMINING FAMILY RELATIONSHIPS FOR ELECTRONIC MEDICAL RECORDS

(71) Applicants: Ralph Neff, Mendon, MA (US); Osama Al-Shaykh, Mendon, MA (US); Barbara Emond, Mendon, MA (US)

(72) Inventors: Ralph Neff, Mendon, MA (US); Osama Al-Shaykh, Mendon, MA (US); Barbara Emond, Mendon, MA (US)

(73) Assignee: NxTec Corporation, Mendon, MA (US)

(21) Appl. No.: 14/554,853

(22) Filed: Nov. 26, 2014

Related U.S. Application Data
(60) Provisional application No. 61/908,841, filed on Nov. 26, 2013.

(51) Int. Cl. G06F 19/00

(52) U.S. Cl. CPC G06F 19/322

(57) ABSTRACT

A system and method for determining family relationships between related individuals for use on electronic medical records (EMRs) in which a first person may provide identifiers of self and/or family members to be associated with the EMR of the first person and a second person may give permission so that information from the EMR of the second person may be shared with the EMR of the first person based on a family relationship, whereby EMR record systems may communicate with each other and/or with an external database in order to determine the family relationships and to determine what information may be shared based on the determined family relationships and permissions.

### CROSS-REFERENCE TO RELATED APPLICATIONS

This application claims priority from U.S. Provisional Patent Application No. 61/908,841 filed Nov. 26, 2013, which is hereby incorporated by reference in its entirety.

### FIELD OF THE INVENTION

Aspects of the invention relate generally to the storage, management and sharing of data, and, more specifically, using relationships between a patient and familial relations of the patient as a basis for sharing electronic medical records of the patient.

### BACKGROUND OF THE INVENTION

Medical or healthcare providers (generally “providers”) and government health care systems are moving to electronic medical records (EMR) because they are more efficient, more portable, and more useful than paper records. Family medical history is an important factor in patient diagnosis and treatment. Providers may base a diagnosis in part on the knowledge that some genetically-related condition was present in a patient's family. For example, providers may recommend annual mammograms for a woman before the typical risk age of 40 if it is known that a familial member, e.g., her sister or mother, had breast cancer. As another example, providers may be more likely to order an esophageal examination for a patient with frequent heartburn if the patient has a sibling, parent or grandparent who contracted esophageal cancer. Currently, diagnoses and medical testing decisions are based on a probability that a patient has a certain condition, given an observed set of symptoms and test results. Thus, knowledge of family history may, in the medical or healthcare provider's mind, significantly alter such probabilities.

For this reason, a patient often is required to provide family medical history in the form of a questionnaire typically filled out by the patient at the provider's office or hospital, usually while waiting for a medical appointment. The questionnaire may pose a series of questions about whether the patient has previously had various medical conditions or illnesses, and also about whether the patient knows of any family history of such conditions or illnesses. These questionnaires typically take the patient some time and effort to complete. At a subsequent medical appointment or at a periodic, e.g. annual, interval, and with each new specialist the patient visits, the patient may be required to update the questionnaire or to complete a new questionnaire. Thus, the patient is repeatedly required to provide redundant information in order to keep the medical or healthcare provider updated with her latest health information.

This may not be an efficient use of the patient's time and patients often do not know all relevant details, especially those dealing with the health histories of family members. Furthermore, in order to add the returned questionnaire to the patient's EMR, the provider must employ staff to enter the data from the (typically) paper form into the computerized EMR system. This is a tedious, costly practice and, likely, not an efficient use of the medical or healthcare provider's staff. Moreover, human typographical errors may be introduced during data entry.

In addition to data entry errors, medical family history information provided by the patient may not be accurate at the time the provider uses the information to diagnose the patient. For example, time may have passed since the patient provided the information and subsequent medical family history events, of which the patient may or may not be aware, may have occurred. In short, if a provider sees a patient six months after the patient last filled out the patient's family medical history portion of the questionnaire, the medical history information in the patient's EMR may not include information about a relative who was diagnosed with cancer or heart disease during the intervening six-month period.

Moreover, the information provided by the patient on the medical family history questionnaire may be inaccurate or incomplete, because the patient may not know the information requested by the form. The patient may not know dates or specific details about medical conditions or illnesses for which the patient's relatives have been diagnosed. This is very common for the more temporally-distant relatives, e.g., grandparents. The patient also may not be in contact with some or all of her blood relatives. As a result, the patient may not be aware of conditions or illnesses diagnosed for certain relatives. Additionally, a relative may in some cases keep a medical condition or diagnosis secret from the patient, or from other relatives, even though the information of the diagnosis may be useful, especially in instances in which the patient might be predisposed to contract the same condition.

For these reasons, there is a need for techniques and supporting systems that automatically populate a patient's EMR with family medical history information without the need for an individual patient to provide the information via a questionnaire. There is also a need to automatically populate a patient's EMR with relevant family medical history information to which the relevant family member authorizes the patient to have access. Moreover, there is a need for a system that automatically populates a patient's EMR with family medical history information while adhering to various state, federal, and professional privacy restrictions.

### SUMMARY OF THE INVENTION

In a first aspect, a method of sharing data from electronic medical records using familial relationships of a patient using a system that includes processing devices and one or more databases in communication via a communication network. In some embodiments, each of the processing devices includes a processing unit, memory, and a first database containing electronic medical records, and the method includes receiving, via a first processing device, identifying information for the patient and retrieving, from a first database associated with the first processing device, identifying information of a familial relation(s) of the patient. The method further includes using the identifying information of the familial relation(s) of the patient, accessing medical history information for any of the familial relations of the patient from the second database(s), and populating an electronic medical record of the patient in the first database with medical history information of any of the familial relations of the patient accessed from the second database and providing an electronic link to the medical history information of any of the familial relations of the patient accessed in the second database.

In some implementations, the identifying information for the patient from the first database is used to identify familial relation(s) of the patient, and identifying familial relations may include locating, in the second database, information of the familial relation. In some variations, information for the patient from the first database includes family history linkage information, such as the patient's name, address, social security number, medical ID number, medical insurance ID number, and identifying information of the patient's family relations. In some instances, information of the patient's family relations includes information of a family relation, such as the family relation's name, address, social security number, medical ID number, medical insurance ID number, identifying information of the family relation's family relations, a relationship between the patient and the family relation, and some portion of the family relation's electronic medical records.

In some implementations receiving identifying information of a familial relation(s) of the patient includes determining, prior to receiving identifying information from a familial relation, a family relation's permission information. Using such information, a determination may be made as to whether the electronic medical records of the familial relation may be shared with the patient. For example, identifying which information of the familial relation that may be shared with the patient may include determining the existence of a condition upon which the identifying information of the familial relation may be shared. Moreover, the patient's electronic medical records may permit sharing of the patient's age, the patient's symptoms, the patient's illness, and/or the patient's initial diagnosis, and/or determining a classification of the familial relationship. In each instance, the techniques follow prescribed processes for adhering to data privacy restrictions imposed by statutes (e.g., HIPAA) and other policies

In a second aspect, a system for sharing data from electronic medical records (EMRs) over a communication network using familial relationships, includes several processing devices, each processing device having a processing unit, memory, a first database, a user interface and database(s) containing electronic medical records of patients, each database corresponding to a discrete processing device. In some implementations, the processing units identify, using data in a corresponding database, familial relation(s) of a patient, and using the familial relations, locate, in a second database, an EMR belonging to the identified familial relation(s). Using the EMR belonging to the identified familial relation(s), the EMR of the patient may be populated. In some implementations a central linkage server is in communication with each database.

In some variations, the processing device is adapted to enable a user to access electronic medical records from a remote site. In some implementations, the processing unit is further configured to determine, prior to receiving identifying information from a familial relation, a family relation's permission information and to determine, from the family relation's permission information, which identifying information from the electronic medical records of the familial relation may be shared with the patient. In some implementations, the processing unit is further configured to determine the existence of conditions upon which the identifying information of the familial relation may be shared or not shared. In some implementations, the processing unit is further configured to determine a classification of the familial relationship. In some implementations, the processing unit is further configured to determine from the patient's electronic medical records the patient's age, the patient's symptoms, the patient's illness, and/or the patient's initial diagnosis.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows an illustrative embodiment of a system for sharing data from electronic medical records using familial relationships in accordance with the present invention; and

FIG. 2 shows a flow chart of an illustrative embodiment of a method of sharing data from electronic medical records using familial relationships in accordance with the present invention.

### DETAILED DESCRIPTION OF THE INVENTION

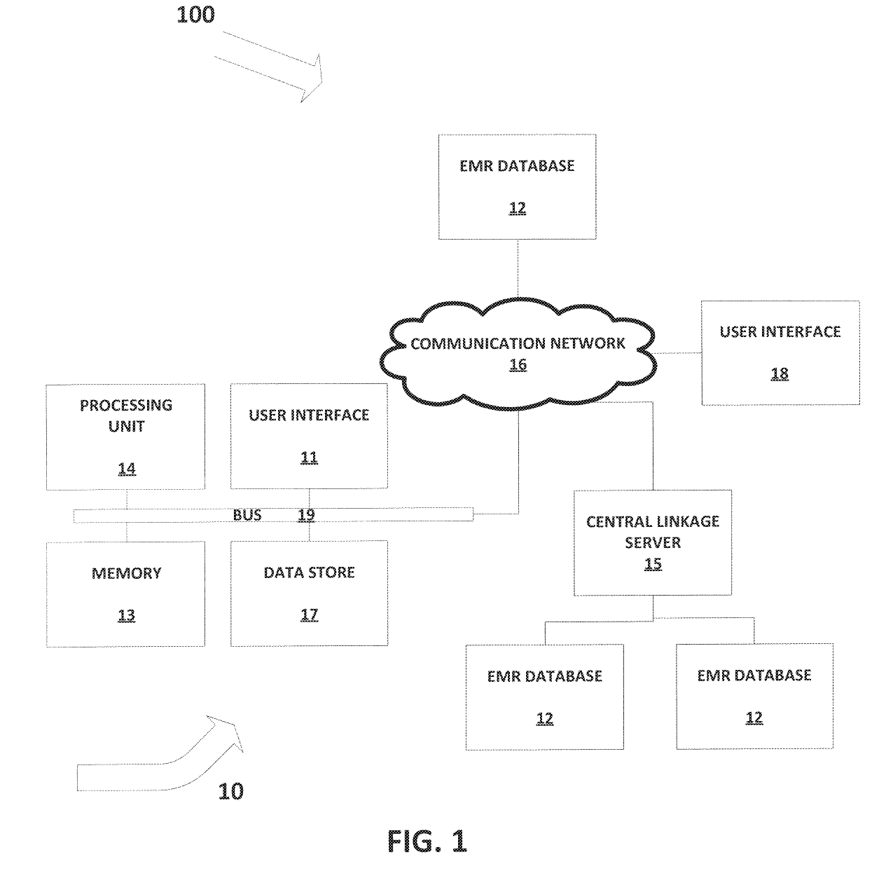

FIG. 1, illustrates one embodiment of a system 100 for sharing data from electronic medical records (EMRs), and more particularly for sharing EMR data among family members using known or derived familial relationships. In some embodiments, the system 100 may be practiced using a computer or processing system that may include one or more general purpose computing or processing devices, i.e., client device 10, including a processing unit 14, a system memory 13, a data storage medium 17, and a system bus 19 that couples the various system components including the system memory 13 to the processing unit 14. A user may enter commands and information into the client device 10 through a user interface 11 that includes input devices such as a keyboard and pointing device, commonly referred to as a mouse, trackball or touch pad. Other input devices 11 may include a microphone, joystick, game pad, satellite dish, scanner, voice recognition device, keyboard, touch screen, toggle switch, pushbutton, or the like. These and other input devices are often connected to the processing unit 14 through a user input interface 11 that is coupled to the system bus 19, but may be connected by other interface and bus structures, such as a parallel port, game port or a universal serial bus (USB).

The processing units 14 that execute commands and instructions may be general purpose computers, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

One or more monitors or display devices may also be connected to the system bus 19, e.g., via an interface 11. In addition to display devices, the client device 10 may also include other peripheral output devices, which may be connected through an output peripheral interface. The client device 10 implementing the invention may operate in a networked environment using logical connections to one or more remote computers. The remote computers typically including many or all of the elements described above. The client device 10 may include a plurality of software processing modules stored in the memory 13 and executed on the processing unit 14 in the manner described herein. The program modules may be in the form of any suitable programming language, which is converted to machine language or object code to allow the processing unit 14 to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Basic, C, C++, CSS, HTML, Java, SQL, Perl, Python, Ruby and/or JavaScript, for example. Further, it is not necessary that a single type of instruction or programming language be utilized in conjunction with the operation of the system and method of the invention. Rather, any number of different programming languages may be utilized as is necessary or desirable. The instructions and/or data used in the practice of the invention may also utilize any compression or encryption technique or algorithm, as desired. An encryption module might be used to encrypt data. Further, files or other data may be decrypted using a suitable decryption module.

A data store 17 may be embodied using any computer data store, including but not limited to relational databases, non-relational databases (NoSQL, etc.), flat files, in memory databases, and/or key value stores. Examples of such data stores include the MySQL Database Server or ORACLE Database Server offered by ORACLE Corp. of Redwood Shores, Calif., the PostgreSQL Database Server by the PostgreSQL Global Development Group of Berkeley, Calif., the DB2 Database Server offered by IBM, Mongo DB, Cassandra, and Redis.

The computing environment may also include other removable/non-removable, volatile/nonvolatile computer storage media 17. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, Storage Area Networking devices, solid state drives, and the like. The storage media 17 are typically connected to the system bus 19 through a removable or non-removable memory interface.

Client devices 10 typically include a variety of computer readable media that can form part of the system memory 13 and be read by the computing or processing unit 14. By way of example, and not limitation, computer readable media may include computer storage media and/or communication media. The system memory 13 may include computer storage media in the form of volatile and/or nonvolatile memory, such as read only memory (ROM) and random access memory (RAM). A basic input/output system (BIOS), containing the basic routines that help to transfer information between components, such as during start-up, is typically stored in ROM. RAM typically contains data and/or program modules that are immediately accessible to and/or presently being operated on by processing unit 14. The data or program modules may include an operating system, application programs, other program modules, and program data. The operating system may be or include a variety of operating systems such as Microsoft Windows® operating system, the Unix operating system, the Linux operating system, the Mac OS operating system, Google Android operating system, Apple iOS operating system, or another operating system or platform.

At a minimum, the memory 13 may include at least one set of instructions that is either permanently (non-volatile) or temporarily (volatile) stored. The processing unit 14 executes the instructions that are stored in order to process data. The set of instructions may include various instructions that perform a particular task or tasks. Such a set of instructions for performing a particular task may be characterized as a program, software program, software, engine, module, component, mechanism or tool.

It should be appreciated that the processing units 14 and/or memories 13 need not be physically in the same location. For example, in some implementations, the system 100 may also include a general purpose computing or processing device, i.e., server device, including a processing unit, a system memory, a data storage medium, and a system bus. Hence, each of the processing units and each of the memories used by the system may be in geographically distinct locations and be connected so as to communicate with each other in any suitable manner. Additionally, it is appreciated that each of the processing units and/or memories may be composed of different physical pieces of equipment.

The devices that embody the invention may communicate with the user via notifications sent over any protocol that can be transmitted over a packet-switched network or telecommunications (“communication”) network 16. By way of example, and not limitation, these may include SMS messages, email (SMTP) messages, instant messages (GChat, AIM, Jabber, etc.), social platform messages (Facebook posts and messages, Twitter direct messages, tweets, retweets, etc.), and mobile push notifications (iOS, Android).

It is understood that the methods and systems described may contain software, middleware, hardware, and any combination thereof connected to, coupled with, and/or in communication with a communication network, e.g., the World Wide Web, the Internet, a local area network (LAN), a wide area network (WAN), and so forth. Computing/processing devices are capable of communicating with each other via the communication network, and it should be appreciated that the various functionalities of the components may be implemented on any number of devices.

The invention may be practiced using any communications network 16 capable of transmitting Internet protocols. A communications network 16 generally connects a client device 10 with a server device, and in the case of peer-to-peer communications, connects two peers. The communication may take place via any media such as standard telephone lines, LAN or WAN links (e.g., T1, T3, 56 kb, X.25), broadband connections (ISDN, Frame Relay, ATM), wireless links (802.11, Bluetooth, 3G, CDMA, etc.), and so on. The communications network 16 may take any form, including but not limited to LAN, WAN, wireless (WiFi, WiMAX), or near field (RFID, Bluetooth). The communications network 16 may use any underlying protocols that can transmit Internet protocols, including but not limited to Ethernet, ATM, VPNs (PPPoE, L2TP, etc.), and encryption (SSL, IPSec, etc.). Although FIG. 1 shows the processing device 10 and the EMR database 12 in communication via the communication network 15, this is done for illustrative purposes only. In some implementations, the processing device 10 and EMR database 12 are hard-wired or wirelessly in communication without the need for an external network 16.

Patients may also practice the invention remotely using any computer system configuration 18 including hand-held wireless devices such as mobile or cellular telephones, personal digital assistants (PDAs), tablet computers, smartphones, smartpads, smartwatches, Google® glasses, tablet computers, laptop computers, personal computers, gaming systems, multiprocessor systems, microprocessor-based or programmable consumer electronics, minicomputers, mainframe computers, computers running under virtualization, and/or any other computing device that is capable of capturing audio and/or video data.

In a second embodiment of the system 100, there may be multiple EMR databases 12, e.g., individual medical service providers such as clinics, hospitals, and/or EMR clearinghouse services, which may each have separate EMR databases 12. In this instance, the various databases may be connected, e.g., via a communication network 16, and, as a result, may query each other according to the above procedure. In configurations where multiple databases 12 are to be queried, the system 10 may include a central linkage server 15 that is configured to act as a go-between to connect the various provider EMR databases 12.

For example, the user interface 11, 18 may be adapted to enable a patient, a medical or healthcare provider, a medical service provider or a staff member of a medical service provider to input family history linkage information to be associated with the patient's EMR. In one variation of the embodiment, family history linkage information may include identifying information of the patient, e.g., name, address, social security number, medical ID number, medical insurance ID number, and the like; and, optionally, identifying information of the patient's family relations, which may include the same fields as previous described plus a relationship field to specify the relationship, e.g., ‘brother,’ ‘sister,’ ‘mother,’ and so forth. In some instances, the familial information may be provided by the patient. In other cases, the system may derive the information from public databases based on the identifying information of the patient or a subset of the familial information.

Family history may also specify the nature of the personal medical history information from the familial member's EMR that may be shared, any information that may not be shared, with whom the information may be shared, and any conditions under which the information may be shared. Providing permission information, settings, and restrictions allows a familial member to control how and with whom her EMR information may be shared. In some implementations, the settings are implemented as an ‘opt-in’ system in which explicit permission must be provided by the familial member patient before information may be shared with others. In other words, until a familial member provides the requisite permission, no information may be shared. In another embodiment, EMR information of a familial member may be automatically shared with specified relatives on the occurrence of a specified event, e.g., at the death or physical incapacity of the familial member.

“Permission information” may include various categories of information. For example, identification of specific types or elements of data within the EMR may be tagged as permitted to be shared with others, or, in some cases, remain private. The identification can be far-reaching and extend to all information or it may be limited to specific classes of illnesses or medical conditions, e.g., genetic diseases, chronic conditions, cardiopulmonary conditions, and so forth; and/or it may be limited to specific illnesses, e.g., diabetes, lung cancer, gout, and so forth. Permission information also may designate with whom such information may or may not be shared. For example, recipients may include all blood relatives, pre-defined classes of relatives (e.g., siblings, children, grandchildren, descendants, and so forth), pre-defined genders (e.g., male or female), discrete, specific relatives (e.g., my son John, my sister Joanna, and the like), and/or relatives whom the familial relation has identified. Permission information may also define the conditions under which the information may be shared. For example, permission information may be unconditional, made conditional upon the occurrence of an event having to do with the granting familial relation (e.g., upon the death of the familial relation), made perpetual to include generations unborn, limited to relatives born or in esse during the familial relation's lifetime, triggered by specific symptoms of the receiving patient (e.g., if a descendent reports symptom X, then it is okay to share information about the familial relation's related condition Y, but, otherwise Y remains undisclosed), and/or conditioned on the age of the receiving family member (e.g., share information about condition X with the familial relation's children once they have turned 40 years old).

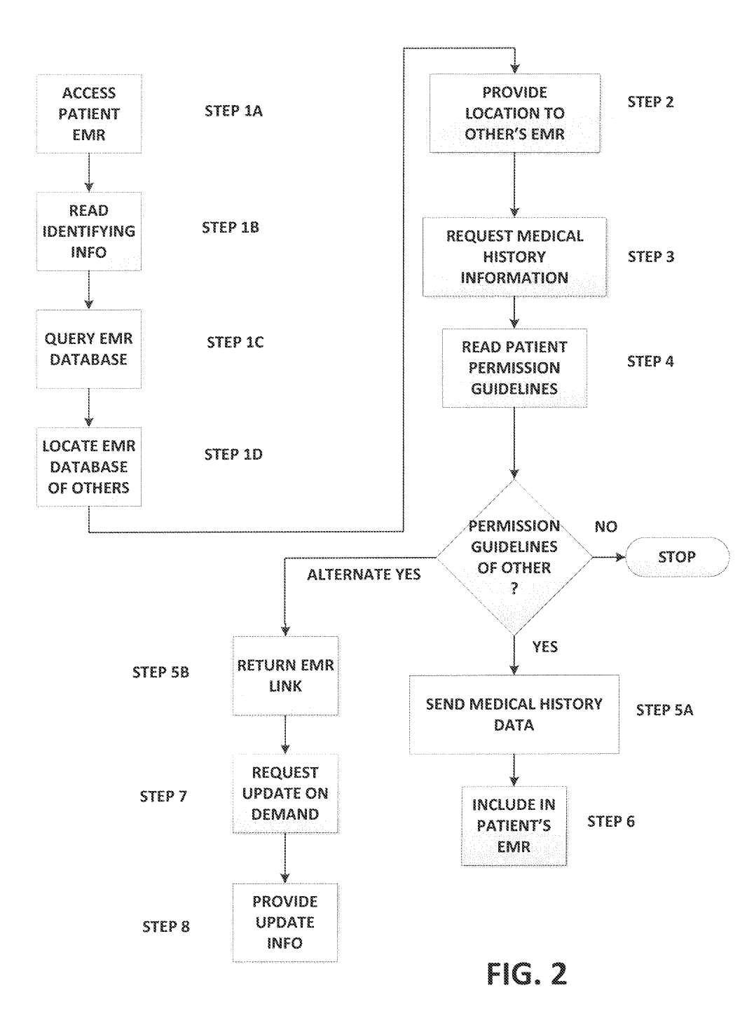

In practice, the system described above implements one or more methods for mining electronic medical records (EMRs) familial relations. In this instance, there may be a single database, e.g., the EMR database of a large government health program or the EMR records of a large medical or healthcare provider. Moreover, it is assumed that each EMR record in the database contains identifying information for the patient and also contains information regarding the patient's familial relations. Referring to the flowchart in FIG. 2, initially, a first processing unit within the system, which, for example, may be executed by a device or software algorithm, receives input from a user, who may be a medical or healthcare provider, a patient, and the like. The first processing unit accesses the EMR of a specified patient (STEP 1A) contained in the EMR database, accesses and reads the patient's identifying information as well as any information regarding the patient's familial relations from the EMR (STEP 1B), and queries the EMR database(s) (STEP 1C) using the identifying information of the patient as well as any information regarding the patient's familial relations (STEP 1A), to locate other EMR records (STEP 1D) that contain, for example, identifying information on one or more familial relations.

For example, the method may include accessing an EMR in an EMR database for ‘John Doe’ (STEP 1A) having a social security number or health care identification number: 555-12-1212. Using this information, the system may query the database (STEP 1C) or another database(s), for example, to locate matches in which John Doe and/or the identification number 555-12-1212 are listed in connection with an identified family relation (STEP 1D). The results returned (STEP 2) may include that Jane Doe (SSN #123-45-6789) lists John Doe (SSN #555-12-1212) as SON and another result may provide that Becky Martin (SSN #987-65-4321) lists John Doe (SSN #555-12-1212) as BROTHER. Thus, the method identifies the patient's mother as ‘Jane Doe’ and the patient's sister as ‘Becky Martin.’ Advantageously, in each instance, the returned results (STEP 2) provide further identifiers and relationships of the patient's family.

Alternatively, when there are multiple EMR databases and a central linkage server, the method may include accessing multiple EMR databases for ‘John Doe’ having a social security number or health care identification number: 555-12-1212. In an initial query, the system may request the central linkage server to find matches in which others list John Doe and/or 555-12-1212 as a family relation. The system may send an individual query to the central linkage server or, alternatively, it may aggregate a plurality of queries, which the system otherwise would send to process multiple EMR databases, and transmit the aggregate collection of queries to the central linkage server at once, i.e., in a single message.

The central linkage server may be adapted to advertise (pull) or broadcast (push) the query to at least one provider database that is known to and in communication with the central linkage server. This may be accomplished efficiently by aggregating multiple queries over a pre-defined period of time, e.g., all queries received by the central linkage server during a one minute span, a one hour span, and the like, or may be sent as a single composite query to all the other provider EMR databases.

Each provider EMR database has a corresponding processing device that responds to the query and/or to the composite query (STEP 2). Those of ordinary skill in the art can appreciate that a single processing device may be associated with more than one database. The database response (STEP 2) may identify family relations for the original patient, John Doe, and/or for the 555-12-1212 identification number, as in the preceding example. In addition, the responses may identify which provider database holds the EMR for the identified family relation. The responses from a provider EMR database may be individual or may be aggregate responses, which respond to multiple queries that have been aggregated and sent from the central linkage server to individual provider EMR databases. When aggregated responses are sent and received, the central linkage server may sort out the responses to identify which original provider database sent the corresponding original query that generated the response.

The central linkage server may then return responses to the processing device of the original provider EMR database (STEP 2) that sent the original query (STEP 1C). The response may be aggregated, i.e., covering multiple queries sent by the same provider EMR database and collecting responses to those multiple queries from multiple remote provider EMR databases. In this instance, upon receiving the aggregated response (STEP 2), the processing device of the original provider EMR database determines which of the responses correspond to each of the original queries previously sent out by the processing device of the original provider database (STEP 1C). In this way, using the central linkage server as a single point of contact, a processing device associated with the original provider database may efficiently query many remote EMR provider databases (STEP 1C) to obtain information on familial relations (STEP 2) corresponding to the EMRs of the original provider database. Aggregation of queries and responses may be used at each step to make the query process efficient, i.e., to reduce the number of messages and the overall network traffic; to reduce overhead between the central linkage server and the provider databases, and the like.

Whether a single database or multiple databases are used, the processing device associated with the provider database that made the original query (STEP 1C) receives responses identifying familial relations of one or multiple original patients (STEP 2). Advantageously, the processing device associated with the original provider database may perform either a single or a multiple databases search, e.g., to identify family relations internal to the original provider database (e.g., if a mother and daughter share the same medical provider) and/or to identify family relations that are likely external to the original provider database. The original provider may then combine the results from the internal and external procedures.

Responses from processing devise associated with remote provider databases (STEP 2) may include the identification of the remote provider along with the identification of the family relation. This facilitates subsequent requests for information from the EMR of the family relation. It is important to note that at this point, none of the EMRs of the identified family relation has been provided to the processing device associated with the original provider database. As will be described in greater detail below, such information is not transmitted until permission information guidelines established by the owners of each EMR have been verified.

Optionally, the system may also use proprietary or “free” ancestry search databases and/or other family record databases to identify and/or locate familial relations. As previously mentioned, even though a user interface may allow a patient, medical or healthcare provider or staff member to enter into the system identifying information of a patient's relatives, e.g., for association with that patient's EMR, some information may not be present in the system, the information may be incomplete, and the like. In this instance, the system, e.g. a device or software, may be configured to query one or more ancestry databases to obtain the family relation information corresponding to a patient. Such ancestry databases may include, without limitation, proprietary databases, e.g., “Ancestry.com,” as well as public record databases, e.g., government records, birth records, tax records that list dependents, marriage records, and so forth. By querying such sources and databases, family relation identifiers that correspond to a patient may be discovered, and such identifiers may then be used as input to the query process listed above in connection with a single or multiple database query. These databases may, for example, provide open API access to the data, in which case the system may use the appropriate API to access the data. In other instances, a custom data feed or port may be needed to access third party data.

Once the database locations of EMRs for a patient's familial relations have been identified, the original provider, which is to say, the provider that manages the original patient's EMR, may send information requests to the remote (external) providers and/or to an internal agent in order to request Family Medical History information to be linked to the original patient's EMR (STEP 3). The receiving provider or internal agent may respond to these information requests (STEP 3) based on the permission information guidelines established by the owners of each requested EMR (STEP 4). For example, the transfer or exchange of requests and responses for information about a relative previously identified at Provider B's database may occur as follows:
From Provider A to Provider B: Send updated information from Joe Hansen (SSN #444-44-1111), to SON Jimmy Hansen (SSN #111-11-4444)
Response from Provider B to Provider A: No data, e.g., because permission not granted by EMR owner.

If, on the other hand, the EMR owner had granted permission, the specific information identified as sharable, e.g., according to the permission information guidelines, may be returned in the response (STEP 5A) for inclusion in the original patient's EMR (STEP 6). Alternately, a placeholder link or bookmark may be returned (STEP 5B) in order to allow the provider that manages the original patient's EMR to request updated information on demand (STEP 7), but only when needed for diagnosis. In this way, information about family medical history is not copied into the original patient's EMR record itself; but, rather, a virtual link(s), e.g., a hyperlink, to the latest family medical information may be built into the original patient's EMR, so that the latest family medical information may be retrieved and provided on an as-needed basis (STEP 8). In this way, the original provider system may build a structure of links to known information stored in the EMRs of family relations (STEP 8), regardless of where such EMRs are stored or of which remote provider may store and/or manage the EMRs of the family relations.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Those of ordinary skill in the art may realize that the invention may be embodied in other specific forms without departing from the spirit or essential characteristics thereof. The foregoing embodiments, together with the attached drawings, are, therefore, to be considered in all respects illustrative rather than limiting of the invention described herein.

What we claim is:

1. A method, using a system comprising a plurality of processing devices in communication and at least one second database via a communication network, of sharing data from electronic medical records using familial relationships of a patient, each of the plurality of processing devices comprising a processing unit, memory, and a first database containing electronic medical records, the method comprising:
receiving, via a first processing device, identifying information for the patient;
retrieving, from a first database associated with the first processing device, identifying information of at least one familial relation of the patient;
using the identifying information of at least one familial relation of the patient, accessing medical history information for any of the at least one familial relations of the patient from the at least one second database; and
populating an electronic medical record of the patient in the first database with at least one of medical history information of any of the at least one familial relations of the patient accessed from the second database and a link to the medical history information of any of the at least one familial relations of the patient accessed in the second database.

2. The method of claim 1 further comprising using the identifying information for the patient to identify at least one familial relation of the patient.

3. The method of claim 2, wherein identifying at least one familial relation includes locating in the second database identifying information of the at least one familial relation.

4. The method of claim 2, wherein using identifying information for the patient from the first database includes family history linkage information selected from a group consisting of the patient's name, address, social security number, medical ID number, medical insurance ID number, and identifying information of the patient's family relations.

5. The method of claim 3, wherein identifying information of the patient's family relations the second database includes identifying information of each family relation of the patient's family relations selected from the group consisting of the family relation's name, address, social security number, medical ID number, medical insurance ID number, identifying information of the family relation's family relations, a relationship between the patient and the family relation, and some portion of the family relation's electronic medical records.

6. The method of claim 1, wherein receiving identifying information of at least one familial relation of the patient includes:
determining, prior to receiving identifying information from a familial relation, a family relation's permission information; and
determining, from the family relation's permission information, which identifying information from the electronic medical records of the familial relation may be shared with the patient.

7. The method of claim 6, wherein determining which identifying information of the familial relation may be shared with the patient includes determining an existence of any condition upon which the identifying information of the familial relation may be shared.

8. The method of claim 6, wherein determining which identifying information of the familial relation may be shared with the patient comprising determining from the patient's electronic medical records at least one of the patient's age, the patient's symptoms, the patient's illness, and the patient's initial diagnosis.

9. The method of claim 6, wherein determining which identifying information of the familial relation may be shared with the patient includes determining a classification of the familial relationship.

10. A system for sharing data from electronic medical records (EMRs) using familial relationships over a communication network, the system comprising:
a plurality of processing devices, each processing device of the plurality of processing devices having a processing unit, memory, a first database, and a user interface;
at least one database containing electronic medical records of a multiplicity of patients, each database of the at least one database corresponding to a discrete processing device of the plurality of processing devices;
wherein each processing unit is configured to:
identify, using data in the first database corresponding to a first processing device associated with the processing unit, at least one familial relation of a patient,
using the familial relations, locate, in a second database, of the at least one database, corresponding to a second processing device, at least one EMR belonging to the identified at least one familial relation, and
populate the EMR of the patient in the first database with the an EMR belonging to the identified at least one familial relation from the second database.

11. The system of claim 10, wherein the at least one database corresponds to a plurality of databases, further comprising a central linkage server that is in communication with each database of the plurality of databases.

12. The system of claim 10 further comprising a processing device that is adapted to enable a user to access electronic medical records from a remote site.

13. The system of claim 10, wherein the processing unit is further configured to:
determine, prior to receiving identifying information from a familial relation, a family relation's permission information; and
determine, from the family relation's permission information, which identifying information from the electronic medical records of the familial relation may be shared with the patient.

14. The system of claim 13, wherein the processing unit is further configured to:
determine an existence of any condition upon which the identifying information of the familial relation may be shared.

15. The system of claim 13, wherein the processing unit is further configured to:
determine a classification of the familial relationship.

16. The system of claim 13, wherein the processing unit is further configured to:
determine from the patient's electronic medical records at least one of the patient's age, the patient's symptoms, the patient's illness, and the patient's initial diagnosis.
